(19) United States
(12) Patent Application Publication
(10) Pub. No.: US 2007/0165193 A1
(43) Pub. Date: Jul. 19, 2007

(54) Projection type image-displaying system, projection type image-displaying apparatus, and lamp lighting-controlling method

(75) Inventors: Yoshio Kubo, Tokyo (JP); Kunikatsu Shimada, Saitama (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/486,121

(22) Filed: Jul. 14, 2006

(30) Foreign Application Priority Data
Jan. 19, 2006 (JP) 2006-011609

(51) Int. Cl. G03B 21/20

(52) U.S. Cl. 353/85

(57) ABSTRACT

The invention provides a projection type image-displaying system in which a user can readily adjust brightness and color purity of a projected image, a projection type image-displaying apparatus, and a lamp lighting-controlling method. A projector apparatus (10) recognizes an apparatus (a PC apparatus (30) or a recording/reproducing apparatus (40)) connected to the projector apparatus (10), and a user or designer selects an image mode menu corresponding to an image signal input and causes the image mode menu thus selected to be displayed on a screen (50). As a result, when a projection type image-displaying system is used, the user or designer can readily and intuitively adjust brightness and color purity in order to obtain ones which he/she likes while looking at an image displayed on the screen (50).

The present application is based on Japanese patent application No. 2006-011609, the entire contents of which are incorporated herein by reference.

### BACKGROUND

1. Field

One embodiment of the invention relates to a projection type image-displaying system for projecting a color image on a screen or the like, a projection type image-displaying apparatus, and a lamp lighting-controlling method for use in these system and apparatus, and more particularly to a projection type image-displaying system in which a white light is divided into lights having respective colors in a time division manner by using a color wheel, the resulting lights are modulated into image lights having respective colors by using an image-displaying device such as a digital micro mirror device (DMD), and the resulting image lights are projected on a screen, a projection type image-displaying apparatus, and a lamp lighting-controlling method for use in these system and apparatus.

2. Description of the Related Art

In recent years, the needs for desiring to more brightly and finely display an image on a large screen have increased, and the demand has rapidly risen for a projector, a consumer liquid crystal television, and the like. In addition, the digital broadcasting of high image quality also begins to become popular, and thus the needs for high image quality promotion and scaling up of a screen have increased year by year.

The needs for high image quality promotion and scaling up have increased, and thus the competitions in the developments of projectors from business ones to consumer ones using the various kinds of image-displaying devices have been developed aiming at the large and brighter screens.

Now, with regard to a system of a projector, a projection type image-displaying apparatus has been commercialized in which a white light emitted from a light source is divided into lights having respective colors in a time division manner by using a color wheel including color filters of R(red), G(green) and B(blue) (hereinafter referred to as “color segments”), the resulting lights are modulated into image lights having respective colors by using an image-displaying device such as a liquid crystal panel or a DMD, and the resulting image lights are projected on a screen or the like.

A high pressure electric discharge lamp from which a high luminance is readily obtained is generally used as a light source for such a projection type image-displaying apparatus. In the case of the high pressure electric discharge lamp, however, its electric discharge may become unstable, the brightness of an image projected on a screen may flicker, and the image quality may be reduced. A projection type system in which while a light emitted from an electric discharge lamp is transmitted through a white segment of a color wheel, a pulse current (hereinafter referred to as “a lamp pulse”) is superimposed on an electric discharge lamp-driving current has been proposed as a projection type system in which such a high pressure electric discharge lamp is prevented from flickering. This projection type system, for example, is disclosed in the Japanese Patent Kokai No. 2004-212890. The electric discharge of the high pressure electric discharge lamp is stabilized with the lamp pulse.

In addition, with regard to another type of control for a lamp, a projection type system has been proposed in which color balance is controlled such that an intensity of a driving current for an electric discharge lamp is changed so as to become the maximum one while a desirable color, i.e., a specific color is generated. This projection type system, for example, is disclosed in the Japanese Patent Kokai No. 2002-49097. This driving current has a lamp pulse for stabilizing electric discharge of an electric discharge lamp, and a duration of the lamp pulse corresponds to a period of time for which a white light is generated.

However, in accordance with the conventional projection type system, a user or designer cannot intuitively adjust the brightness and the color purity corresponding to his/her taste for an image projected on a screen. For example, when a combination of the projector apparatus and the screen is changed, the sight may differ even for the same image due to a difference in screen gain or the like. Thus, even in the case where the repetitive adjustment is required when the desired image is displayed, preferably, a manipulation is readily carried out.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic constructional view showing a projection type image-displaying system according to a first embodiment of the present invention;

FIG. 2 is an exemplary perspective view of a projector apparatus provided in the projection type image-displaying system according to the first embodiment of the present invention;

FIG. 3 is an exemplary front view showing a main body manipulation portion of the projector apparatus provided in the projection type image-displaying system according to the first embodiment of the present invention;

FIG. 4 is an exemplary front view showing a construction of a remote controller provided in the projection type image-displaying system according to the first embodiment of the present invention;

FIG. 5 is an exemplary schematic constructional view showing an image-forming portion of the projector apparatus provided in the projection type image-displaying system according to the first embodiment of the present invention;

FIG. 6 is an exemplary block diagram of the projector apparatus provided in the projection type image-displaying system according to the first embodiment of the present invention;

FIGS. 7A and 7B are respectively an exemplary timing chart showing lamp pulse-superimposing control for superimposition of a pulse current on a red segment by a lamp-controlling portion in the first embodiment of the present invention, and an exemplary timing chart showing lamp pulse-superimposing control for superimposition of the pulse current on a white segment by the lamp-controlling portion in the first embodiment of the present invention;

FIG. 8 is an exemplary state transition diagram of the projection type image-displaying system according to the first embodiment of the present invention;

FIGS. 9A and 9B are respectively an exemplary diagram partially showing an image mode menu which corresponds to a PC apparatus and which is displayed on a screen, and an exemplary diagram partially showing an image mode menu which corresponds to a recording/reproducing apparatus and which is displayed on the screen;

FIG. 10 is an exemplary flow chart showing an operation of the projection type image-displaying system according to the first embodiment of the present invention;

FIG. 11 is an exemplary state transition diagram of a projection type image-displaying system according to a second embodiment of the present invention;

FIGS. 12A, 12B and 12C are respectively an exemplary diagram of a display picture about a display image of a setting display menu, a diagram of a display picture about a first display image of an image adjustment menu, and an exemplary diagram of a display picture about a second display image of the image adjustment menu, these three kinds of display pictures being displayed in accordance with respective manipulations for a menu switch when RGB signals are inputted as image signals; and

FIGS. 13A, 13B and 13C are respectively an exemplary diagram of a display picture about a display image of a setting display menu, an exemplary diagram of a display picture about a first display image of an image adjustment menu, and an exemplary diagram of a display picture about a second display image of the image adjustment menu, these three kinds of display pictures being displayed in accordance with respective manipulations for the menu switch when a Video signal, an S-Video signal or an Y/P_{B}/P_{R} signal is inputted as the image signal.

### DETAILED DESCRIPTION OF PREFERRED EMBODIMENTS

Various embodiments according to the invention will be described hereinafter with reference to the accompanying drawings. In general, according to one embodiment of the invention, there is provided a projection type image-displaying system, including: a first terminal apparatus for outputting first image signals; a second terminal apparatus for outputting second image signals; a projection type image-displaying apparatus; and a screen having a projection surface on which image lights are projected; the projection type image-displaying apparatus including: a disk-like color wheel constituting a plurality of color filters including a plurality of color segments for transmitting lights having colors different from one another, respectively; a lamp for radiating a light to the disk-like color wheel, thereby generating lights having transmission colors corresponding to the plurality of color filters, respectively; a lamp-controlling portion for superimposing a control current on a driving current for the lamp for a period of time for which the light is radiated from the lamp to one selected among the plurality of color filters; an optical modulation portion for being driven in accordance with the first image signals or the second image signals to reflect the lights transmitted through the plurality of color filters, respectively, in accordance with the image signals, thereby generating the image lights; and a control portion connected to the first and second terminal apparatuses for causing an image adjustment menu to be projected on the screen in accordance with a user manipulation, the image adjustment menu having set contents to vary the superimposition of the control current on the driving current in correspondence to the first image signals or the second image signals.

In addition, according to one embodiment of the invention, there is provided a projection type image-displaying apparatus, including: a disk-like color wheel constituting a plurality of color filters including a plurality of color segments for transmitting lights having colors different from one another, respectively; a lamp for radiating a light to the disk-like color wheel, thereby generating lights having transmission colors corresponding to the plurality of color filters, respectively; a lamp-controlling portion for superimposing a pulse current on a driving current for the lamp for a period of time for which the light is radiated from the lamp to one selected among the plurality of color filters; an optical modulation portion for being driven in accordance with image signals to reflect the lights transmitted through the plurality of color filters, respectively, in accordance with the image signals, thereby generating image lights; and a control portion for causing an image adjustment menu to be projected on the screen in accordance with a user manipulation, the image adjustment menu having set contents to vary the superimposition of the pulse current on the driving current in correspondence to the image signals.

Also, according to one embodiment of the invention, there is provided a lamp lighting-controlling method, including: visually observing image lights projected from a projection type image-displaying apparatus on a projection surface of a screen; reading out a menu to adjust brightness or color purity of the image lights by manipulating the projection type image-displaying apparatus; setting an adjustment amount corresponding to the brightness or the color purity in accordance with the manipulation of a main body manipulation portion provided on the projection type image-displaying apparatus or a remote controller by looking at the adjustment amount for the brightness or the color purity to be indicated in the menu; and superimposing a pulse current on a driving current for a lamp for radiating a light to a disk-like color wheel in accordance with an input manipulation using the main body manipulation portion or the remote controller, the disk-like color wheel constituting a plurality of color filters including a plurality of color segments, respectively.

According to the present invention, a user can readily control the brightness or color purity of the image projected on the screen.

### First Embodiment

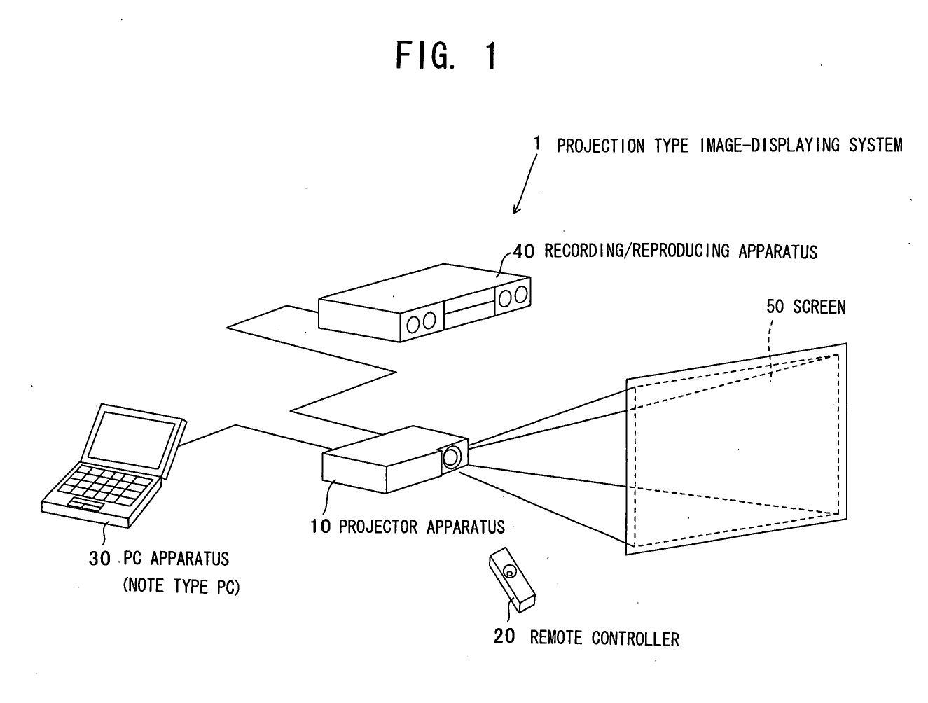

FIG. 1 is a schematic constructional view showing a projection type image-displaying system 1 according to a first embodiment of the present invention.

[Constructions of Portions]

The projection type image-displaying system 1 includes a projector apparatus 10 for emitting image lights generated in accordance with an image such as a still image or a moving image, a remote controller 20 for remotely controlling the projector apparatus 10, a personal computer (PC) apparatus 30 connected to the projector apparatus 10, a recording/reproducing apparatus 40 connected to the projector apparatus 10 for reproducing image data, on a still image, a moving image or the like, recorded in a digital versatile disk (DVD) or a hard disc drive, and a screen 50 on which an image based on the image lights projected from the projector apparatus 10 is displayed.

The projector apparatus 10 divides a light emitted from a high pressure electric discharge lamp (lamp) as a light source in a time division manner by using a color wheel including color segments of R(red), G(green), B(blue) and W(white), makes the resulting lights incident to a DMD device as an optical modulation portion which will be described later to modulate the resulting lights thus made incident thereto into image lights having respective colors, and projects the resulting image lights on the screen 50. The image signals which are inputted to an image-displaying device includes RGB signals which are inputted from the PC apparatus 30, and Video image signals such as a Video signal, an S-Video signal and a component (Y/P_{B}/P_{R}) signal which are inputted from the recording/reproducing apparatus 40.

The remote controller 20 has a plurality of button-like switches with which the projector apparatus 10 is manipulated, and transmits an optical signal corresponding to a manipulation for corresponding one selected among the plurality of button-like switches from its light-transmitting portion to the projector apparatus 10, thereby remotely controlling the projector apparatus 10.

The PC apparatus 30 has an RGB terminal through which data generated by a word processor or an application for table calculation, or an image signal, on a moving image or the like, reproduced by a CD/DVD drive provided in the PC apparatus 30 is outputted in the form of the RGB signals. The RGB terminal and a terminal for computer connection of the projector apparatus 10 are connected to each other through a cable.

The recording/reproducing apparatus 40 has a component terminal through which data, on an image or the like, reproduced by a TV tuner, a disk drive and a hard disk drive which are built in the recording/reproducing apparatus 40 is outputted in the form of the Y/P_{B}/P_{R} image signal. The component terminal and the terminal for computer connection are connected to each other through a cable.

The screen 50 includes a projection surface having a screen gain which represents sufficient brightness when a user visually observes image lights which are emitted from the projector apparatus 10 and are then reflected by the projector surface of the screen 50.

With regard to the connection between the projector apparatus 10 and each of the apparatuses 30 or 40, the wireless connection employing a wireless local area network (LAN) or the like may be adopted in addition to the cable connection illustrated in FIG. 1.

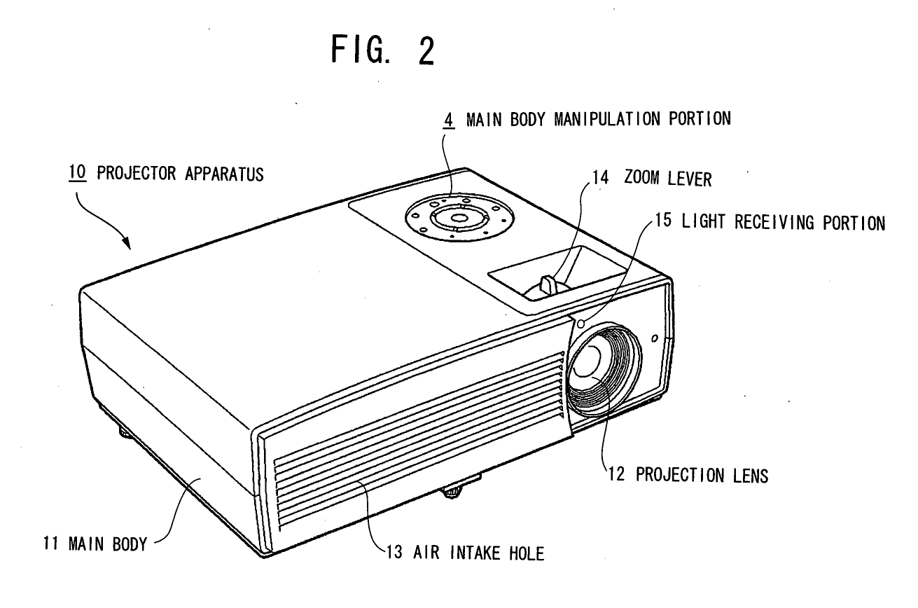

FIG. 2 is a perspective view of the projector apparatus 10 provided in the projection type image-displaying system 1 according to the first embodiment of the present invention.

The projector apparatus 10 has a rectangular main body 11, and also has a projection lens 12 which is provided in a front face of the main body 11, an air intake hole 13 which is provided in the front face of the main body 11 adjacently to the projection lens 12, a zoom lever 14 for adjusting a size of an image, a light-receiving portion 15 for receiving an optical signal transmitted from the remote controller 20, and a main body manipulation portion 4 which is provided on an upper surface of the main body 11 and which includes a plurality of switches to manipulate the corresponding portions of the projector apparatus 10, respectively, and indicators.

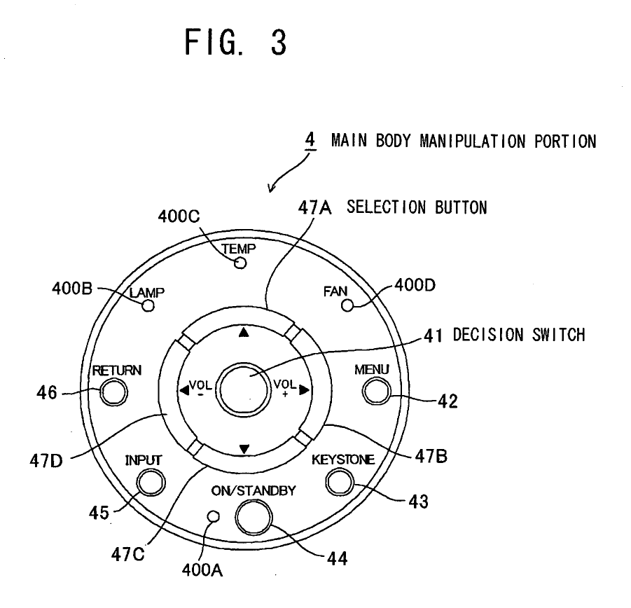

FIG. 3 is a front view showing the main body manipulation portion 4 of the projector apparatus 10 provided in the projection type image-displaying system 1 according to the first embodiment of the present invention.

The main body manipulation portion 4 is constructed such that a plurality of switches and the indicators which are constituted by light-emitting elements, respectively, are disposed annularly around a decision switch 41 with the decision switch 41 as a center. A menu switch 42 to make menu display, a keystone switch 43 to adjust a keystone distortion, an ON/standby switch 44 to perform turn-ON/OFF and standby of a power source, an input switch 45 to perform input switching for image signals, a return switch 46 to return current display back to preceding display, an ON/standby indicator 400A for indicating an ON/standby state, a lamp indicator 400B for displaying a mode of a lamp built in the main body 11, a temperature indicator 400C which is turned ON when an internal temperature of the projector apparatus 10 is high, and a fun indicator 400D for displaying a mode of a cooling fun are annularly disposed as a first switch group around the decision switch 41.

In addition, selection switches 47A to 47D to perform selection, adjustment, and volume adjustment on the menu, respectively, are annularly disposed as a second switch group on an inner side of the first switch group.

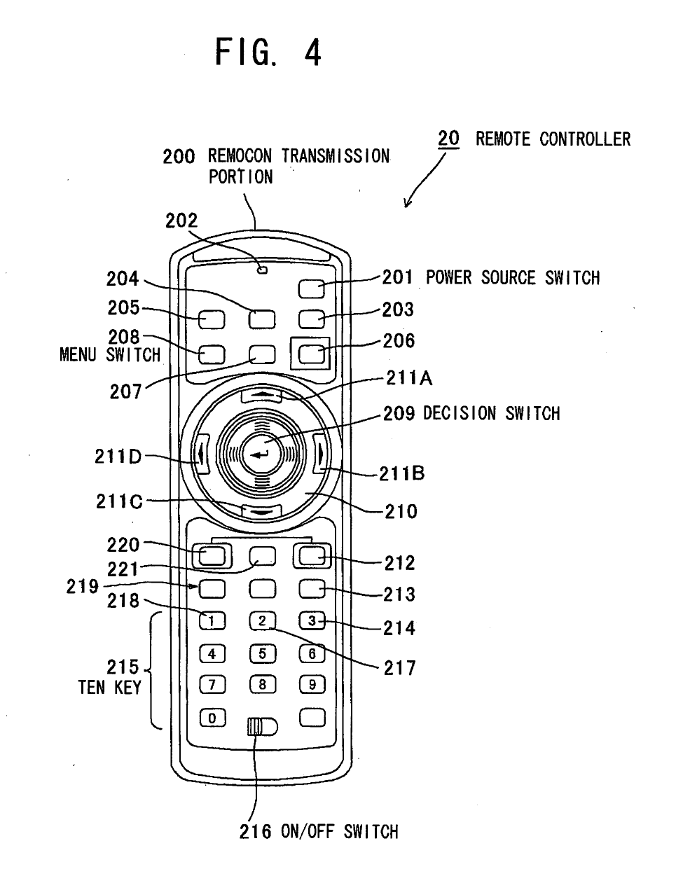

FIG. 4 is a front view showing a construction of the remote controller 20 provided in the projection type image-displaying system 1 according to the first embodiment of the present invention.

The remote controller 20 has a remocon transmission portion 200 for emitting an optical signal (laser beam) in accordance with a switch manipulation, an ON/standby switch 201 to perform turn-ON/OFF and standby of the power source of the projector apparatus 10, a laser indicator 202 which is turned ON when the remocon transmission portion 200 emits the laser beam, a keystone switch 203 to adjust a keystone distortion, an auto set switch 204 to make setting when an analog signal is inputted from the PC apparatus 30, an input switch 205 to perform input switching for the image signal, a laser switch 206 to display a pointer as a laser pointer, a return switch 207 to return current display back to preceding display, a menu switch 208 to perform menu display, a decision switch 209, and a mouse-controlling switch 210 to control a mouse pointer. Also, the remote controller 20 has selection switches 211A to 211D which are annularly disposed around the decision switch 209, a PAGE+switch 212 which is used in the progress of slides, a mute switch 213 to temporarily stop reproduction of an image and a sound, a freeze switch 214 to stop the reproduction of an image, a ten key 215 including switches of numerical characters from 0 to 9 and an clear switch, an ON/OFF switch 216 to turn ON/OFF a power source of the remote controller 20, a screen size switch 217 to change a current image size to another one, a picture switch 218 to change a current image mode to another one, a resize switch 219 to extend/reduce an image, a PAGE−switch 220 which is used in the putting back or the like of the slides, and an R click switch 221 which is used as a right click switch in a mouse function. In addition, an L click switch which is used as a left click switch in the mouse function is provided on a rear face (not shown) of the remote controller 20.

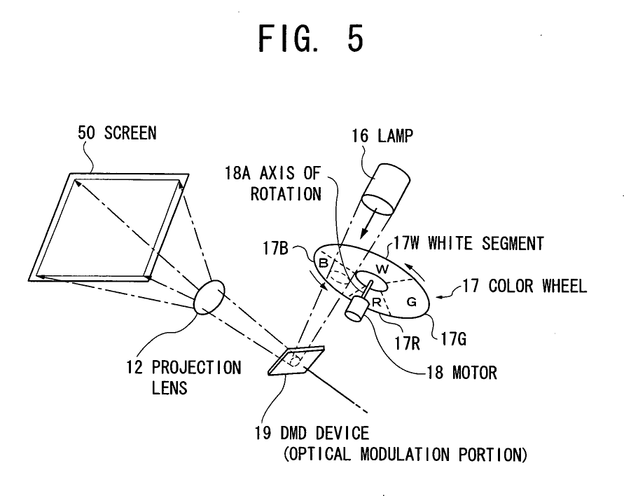

FIG. 5 is a schematic constructional view showing an image-forming portion of the projector apparatus 10 provided in the projection type image-displaying system 1 according to the first embodiment of the present invention.

The image-forming portion includes a lamp 16, constituted by a high pressure electric discharge lamp, for emitting a white light, a disk-like color wheel 17 including a red segment 17R, a green segment 17G, a blue segment 17B and a white segment 17W, a motor 18 for rotating the disk-like color wheel 17 mounted to its axis 18A of rotation, a DMD device 19, constituted by a plurality of fine mirror elements, for controlling color gradations of the image lights emitted through the projection lens 12 by controlling angles of inclination of the respective mirror elements, and the projection lens 12 for projecting the lights reflected by the DMD element 19 on the screen 50.

Each of the red segment 17R, the green segment 17G and the blue segment 17B of the disk-like color wheel 17, for example, is constituted by a dichroic filter having such a property that a light having a wavelength falling within a wavelength range of a visible light is made to selectively pass. Incidentally, the white segment 17W may be a transparent filter for a luminous color in the first embodiment since the color of the light emitted from the lamp 16 is white.

The motor 18 drives and rotates the disk-like color wheel 17 synchronously with an image field of image signals supplied to the DMD device 19. The motor 18, for example, drives and rotates the disk-like color wheel 17 at a rotational speed of 120 rotations/second.

In the DMD device 19, micro mirrors are disposed in correspondence to pixels of an image, respectively. The micro mirrors are subjected to ON/OFF control in correspondence to an input image signal. When a certain micro mirror is in an ON state, its inclination is controlled such that the light emitted from the lamp 16 is directed to the screen 50. For example, when a red component image signal is supplied to the DMD device 19, the micro mirror corresponding to the red component image signal becomes an ON state, the red light transmitted through the red segment 17R of the disk-like color wheel 17 is radiated to the DMD device 19, and a red component image the light of which is reflected by the corresponding micro mirror is projected on the screen 50 through the projection lens L2. Each of ON periods of time of the micro mirrors is determined in correspondence to a value (pixel value) of an image signal inputted thereto.

Incidentally, the light when the light emitted from the lamp 16 is radiated to any of boundary portions among the color segments is not projected on the screen 50. In addition, when the light emitted from the lamp 16 is radiated to the white segment 17W, the DMD device 19 reflects the white light to the screen 50 by optimally controlling the ON period of time of the micro mirror corresponding to the input image signal supplied thereto.

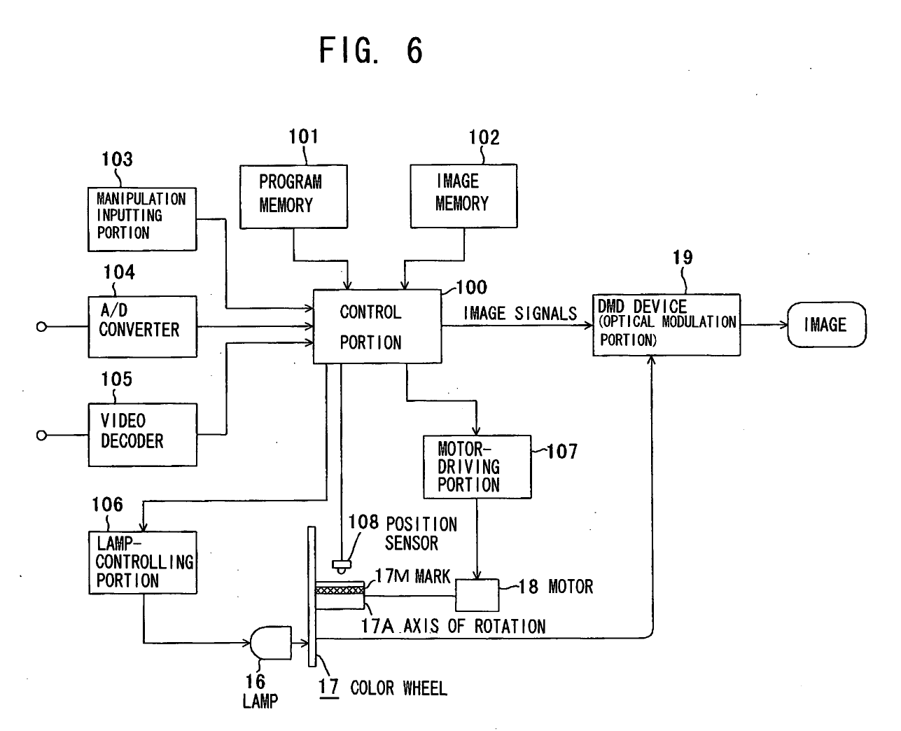

FIG. 6 is a block diagram of the projector apparatus 10 provided in the projection type image-displaying system 1 according to the first embodiment of the present invention.

The projector apparatus 10 has a control portion 100 for performing pulse-superimposing control in accordance with which a pulse current is superimposed on a driving current for the lamp 16 at timing corresponding to the color segments, a program memory 101, constituted by a non-volatile memory, for storing therein firmware of the projector apparatus 10 and a program required for an operation of the projector apparatus 10, and data on a lamp waveform and the like, an image memory 102, constituted by a non-volatile memory, for storing therein data on images about the various kinds of setting pictures and the like, a manipulation-inputting portion 103 including the main body manipulation portion 4 provided in the main body 11 and the light-receiving portion 11 of the remote controller 20, an A/D converter 104 for converting analog image signals as the input image signals into digital image signals, a video decoder 105 for decoding video image signals as the input image signals, a lamp-controlling portion 106 for controlling the lighting of the lamp 16, a motor-driving portion 107 for supplying a driving current to the motor 18 for driving and rotating the disk-like color wheel 17, and a position sensor 108 for optically detecting a mark 17M formed on an axis 17A of rotation of the disk-like color wheel 17 mounted to the axis 18A of rotation of the motor 18.

The position sensor 108 detects a reflected light which is obtained by reflecting a light emitted from a sensor light source by the mark 17M made of a reflective material and formed on the axis 17A of rotation of the disk-like color wheel 17 at its photo interrupter, thereby detecting a phase of the disk-like color wheel 17. The control portion 100 determines the timing at which the lamp pulse is superimposed on the driving current in accordance with a phase detection signal, about the disk-like color wheel 17, from the position sensor 108.

The control portion 100 controls the DMD device 19, the lamp-controlling portion 106, and the motor-driving portion 107 in accordance with respective manipulation signals inputted from the manipulation-inputting portion 103. The control portion 100 transmits a lamp waveform control signal and a lamp power control signal corresponding to the image set value to the lamp-controlling portion 106 in accordance with a manipulation signal inputted from the main body manipulation portion 4 or the remote controller 20, and drives the DMD device 19 in correspondence to the image signals, thereby changing color balance of an image.

The lamp waveform control signal contains therein a synchronous signal for the disk-like color wheel 17 and a signal used to define a lamp pulse width and a lamp pulse height. The pulse current having an arbitrary width and an arbitrary height can be supplied to an arbitrary segment position of the disk-like color wheel 17 in accordance with the lamp waveform control signal.

The lamp power control signal is a signal (e.g., a signal complying with a PWM system) used to correct a lamp power which changes in accordance with a change in pulse width and pulse height of the lamp waveform control signal. Thus, the lamp power can be held at an arbitrary given value in accordance with the lamp power control signal.

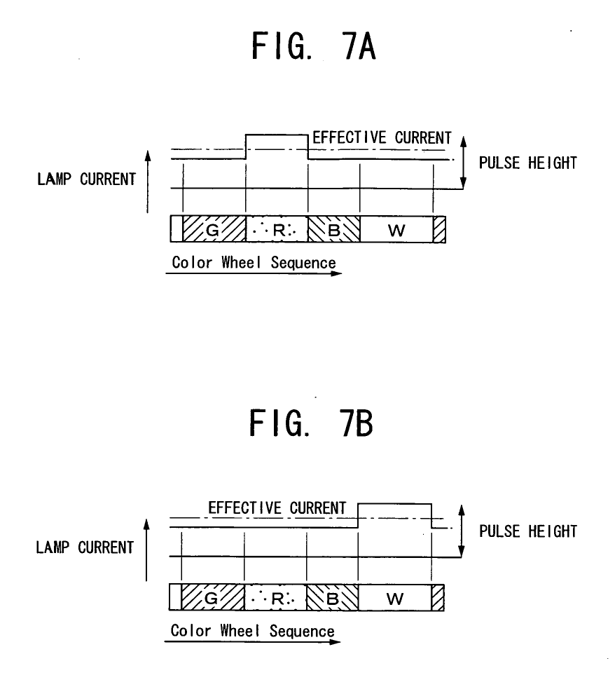

FIGS. 7A and 7B are respectively a timing chart showing lamp pulse-superimposing control for superimposition of the pulse current on the red segment 17R by the lamp-controlling portion 106 in the first embodiment of the present invention, and a timing chart showing lamp pulse-superimposing control for superimposition of the pulse current on the white segment 17W by the lamp-controlling portion 106 in the first embodiment of the present invention. In the disk-like color wheel 17, the four segments illustrated in FIGS. 17A and 17B form one period, and in a rotational sequence of the disk-like color wheel 17, this period is repeated in accordance with the rotation.

FIG. 7A shows a state in which the lamp pulse is superimposed on the driving current synchronously with the red segment 17R of the disk-like color wheel 17 while an effective current of the lamp 16 is held constant. In this state, an optical output of the lamp 16 in the red segment 17R is improved. From this, the red component of the image projected on the screen 50 increases.

FIG. 7B shows a state in which the lamp pulse is superimposed on the driving current synchronously with the white segment 17W of the disk-like color wheel 17 while the effective current of the lamp 16 is held constant. In this state, an optical output of the lamp 16 in the white segment 17W is improved. From this, the brightness of the image projected on the screen 50 increases.

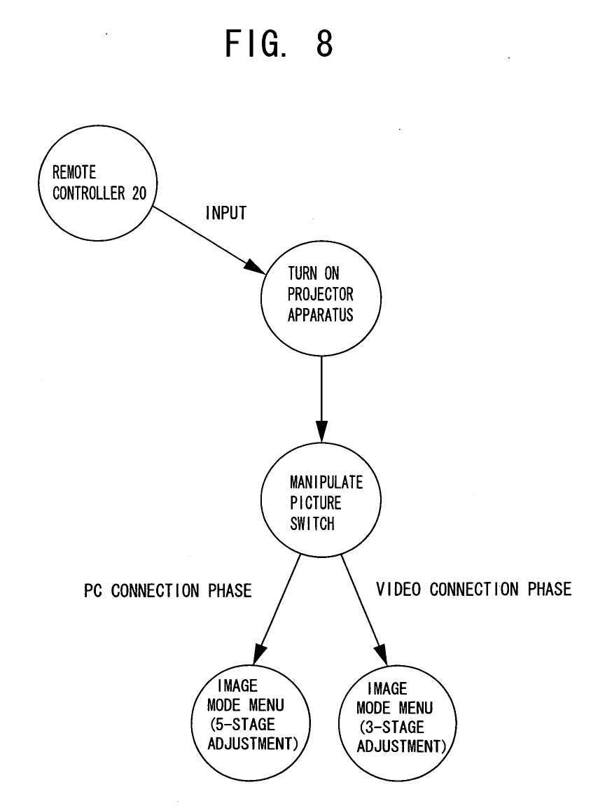

FIG. 8 is a state transition diagram of the projection type image-displaying system 1 according to the first embodiment of the present invention.

After the PC apparatus 30 and the recording/reproducing apparatus 10 are connected to the projector apparatus 10 through the respective cables as shown in FIG. 1, the power source of the projector apparatus 10 is turned ON by manipulating the ON/standby switch 201 of the remote controller 20. When being normally activated, the projector apparatus 10 becomes an image signal input standby state after an initial image such as a LOGO is displayed on the screen 50. Next, when a picture switch of the remote controller 20 or the main body manipulation portion 4 is manipulated, an image mode menu corresponding to the apparatus which outputs the signals to the projector apparatus 10 is displayed on the screen 50. Incidentally, the power source of the projector apparatus 10 may be turned ON by manipulating the ON/standby switch 44 of the main body manipulation portion 4 provided in the main body 11 of the projector apparatus 10.

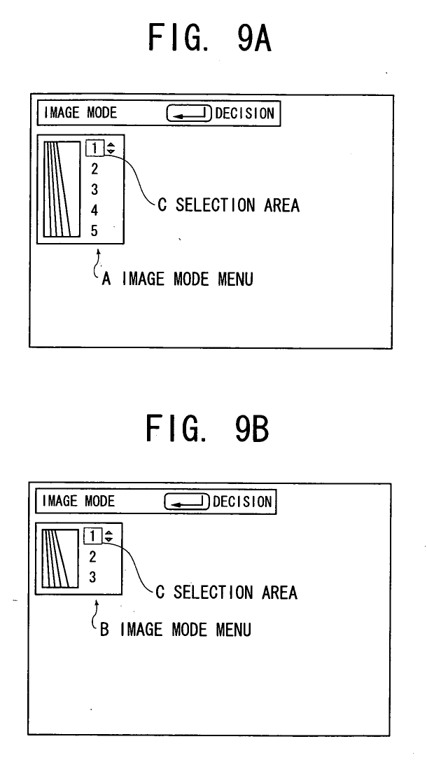

FIGS. 9A and 9B are respectively a diagram partially showing an image mode menu A which corresponds to the PC apparatus 30 and which is displayed on the screen 50, and a diagram partially showing an image mode menu B which corresponds to the recording/reproducing apparatus 40 and which is displayed on the screen 50.

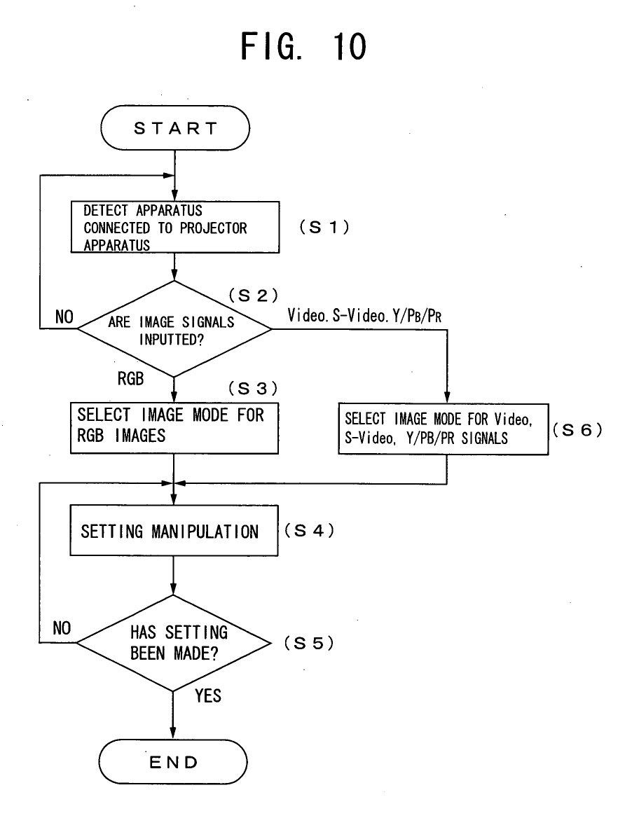

FIG. 10 is a flow chart showing an operation of the projection type image-displaying system 1 according to the first embodiment of the present invention. The operation of the projection type image-displaying system 1 will be described hereinafter with reference to pictures of the image mode menus shown in FIGS. 9A and 9B, respectively.

For example, when the PC apparatus 30 connected to the projector apparatus 10 is activated (S1) and outputs the image signals to the projector apparatus 10, the control portion 100 of the projector apparatus 10 recognizes that the image signals are outputted to the projector apparatus 10 (S2: RGB). When the picture switch of the main body manipulation portion 4 or the remote controller 20 is manipulated, the projector apparatus 10 reads out the image mode adjustment program from the program memory 101, and also reads out the data on the image of the image mode menu A which corresponds to the PC apparatus 30 and which is shown in FIG. 9A from the image memory 20 and outputs the data thus read out in the form of the image signals (S3).

In the image mode menu A corresponding to the PC apparatus 30, for the image signals based on the RGB signals, the adjustment of five stages can be made with respect to the brightness and color purity of image lights. That is to say, the adjustment stage “1” corresponds to the adjustment for the brightness, and the adjustment stages from “2” to “5” correspond to the adjustment for the color rendering property. When the adjustment stage “1” is selected, there is performed the lamp pulse-superimposing control at the timing at which the light is radiated from the lamp 16 to the white segment 17W of the disk-like color wheel 17. In addition, when any one of the adjustment stages from “2” to “5” is selected, there is performed the lamp pulse-superimposing control at the timing at which the light is radiated from the lamp 16 to the red segment 17R of the disk-like color wheel 17. In this case, each of the lamp pulses which are different in pulse height and pulse width from one another depending on the selected modes is superimposed on the driving current.

In the image mode, after a selection area C is moved to the stage corresponding to a desired adjustment amount by manipulating the selection switch of the main body manipulation portion 4 or the remote controller 20 (S4), the setting is reflected in the operation by manipulating the decision switch of the main body manipulation portion 4 or the remote controller 20 (S5).

On the other hand, when the recording/reproducing apparatus 40 connected to the projector apparatus 10 is activated (S1) and outputs the image signals to the projector apparatus 10, the control portion 100 of the projector apparatus 10 recognizes that the image signals are outputted to the projector apparatus 10 (S2: Video, S-Video, Y/P_{B}/P_{R}). Then, the projector apparatus 10 reads out the image mode adjustment program from the program memory 101, and also reads out the data on the image of the image mode menu which corresponds to the recording/reproducing apparatus 40 and which is shown in FIG. 9B from the image memory 102 and outputs the data thus read out in the form of the image signals (S6).

In the image mode menu B corresponding to the recording/reproducing apparatus 40, for the image signals based on the Video signal, the S-Video signal, and the Y/P_{B}/P_{R} signal, the adjustment of three stages can be made with respect to the brightness and color purity of image lights. That is to say, the adjustment stage “1” corresponds to the adjustment for the brightness, and the adjustment stages “2” and “3” correspond to the adjustment for the color rendering property. When the adjustment state “1” is selected, there is performed the lamp pulse-superimposing control at the timing at which the light is radiated from the lamp 16 to the white segment 17W of the disk-like color wheel 17. In addition, when the adjustment stage “2” or “3” is selected, there is performed the lamp pulse-superimposing control at the timing at which the light is radiated from the lamp 16 to the red segment 17R of the disk-like color wheel 17. In this case, each of the lamp pulses which are different in pulse height and pulse width from one another depending on the selected modes is superimposed on the driving current.

According to the first embodiment of the present invention, the control portion 100 of the projector apparatus 10 recognizes the apparatus (the PC apparatus 30 or the recording/reproducing apparatus 40) connected to the projector apparatus 10, and the image mode menu corresponding to the input of the image signals is selected to be displayed on the screen 50. As a result, when the projection type image-displaying system 1 is used, a user or designer can readily and intuitively adjust the brightness and the color purity in order to obtain desired ones which he/she likes while looking at the image displayed on the screen 50.

In the first embodiment, the description has been given with respect to the construction in which the lamp pulse-superimposing control is performed in correspondence to the white segment 17W and the red segment 17R. However, the lamp pulse-superimposing control may be performed for other segments as well. For example, the lamp pulse-superimposing control is performed for the green segment 17G which is effective in compensating for a green region for which a human being has a high visual sensitivity, whereby it is possible to perform the adjustment at aiming at mainly enhancing the color reproducibility.

In addition, in the first embodiment, the description has been given with respect to the construction in which the image mode menu is read out in accordance with the manipulation for the picture switch of the main body manipulation portion 4 or the remote controller 20. However, the image mode menu can also be manipulated in accordance with the setting display menu which is read out in accordance with the manipulation for the menu switch.

### Second Embodiment

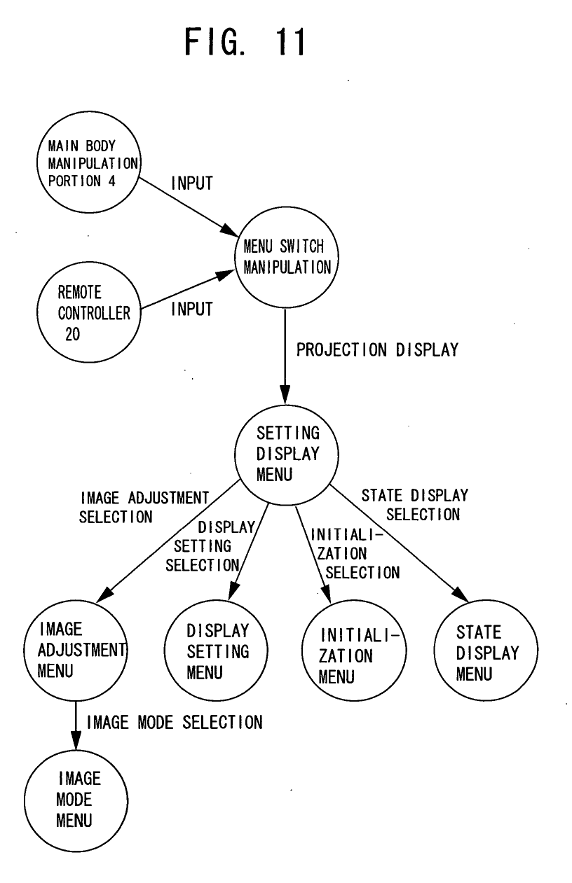

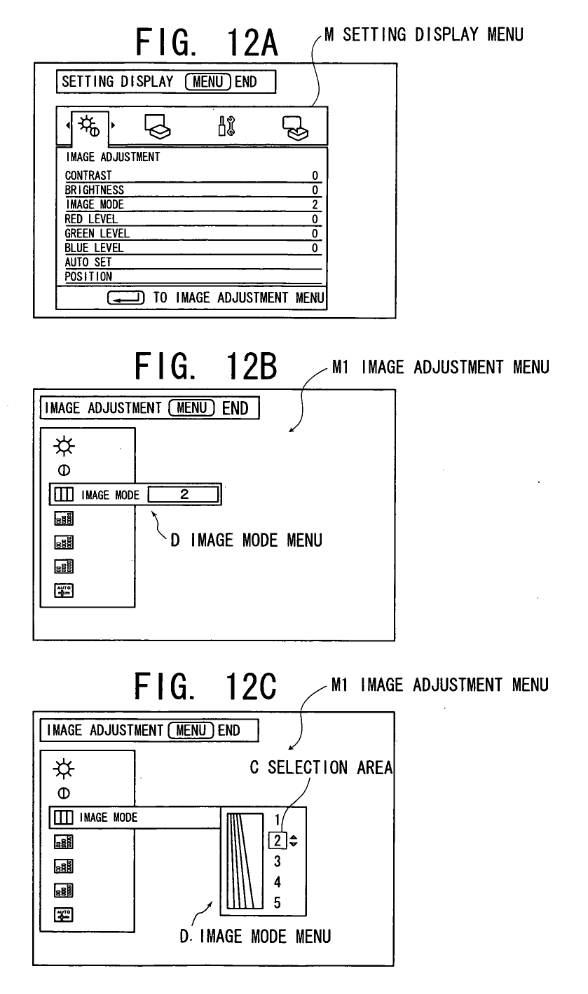

FIG. 11 is a state transition diagram of a projection type image-displaying system according to a second embodiment of the present invention. FIGS. 12A, 12B and 12C are respectively a diagram of a display picture about a display image of a setting display menu, a diagram of a display picture about a first display image of an image adjustment menu, and a diagram of a display picture about a second display image of the image adjustment menu, these three kinds of display pictures being displayed in accordance with respective manipulations for a menu switch when the RGB signals are inputted as the image signals. In the following description, the portions having the same constructions and functions as those of the portions in the first embodiment are designated with the same reference numerals, respectively.

In the second embodiment, the menu switch of the main body manipulation portion 4 or the remote controller 20 is manipulated in the ON state of the projector apparatus 10, whereby a setting display menu M shown in FIG. 12A is displayed on the screen 50.

The setting display menu M contains therein an image adjustment menu, a display setting menu, an initialization menu, and a state display menu. The menu is changed with its display to another one by manipulating the selection switch of the main body manipulation portion 4 or the remote controller 20.

FIG. 12B shows a state in which an image adjustment menu M1 is selected from the setting display menu M, and an image mode is selected from the image adjustment menu M1. Here, when the image mode is intended to be changed to another one, an image mode menu D is displayed by manipulating the selection switch. After a selection area C contained in the image mode menu D is moved to the adjustment stage corresponding to a desired adjustment amount, the menu switch of the main body manipulation portion 4 or the remote controller 20 is manipulated, resulting in that the setting is reflected in the operation.

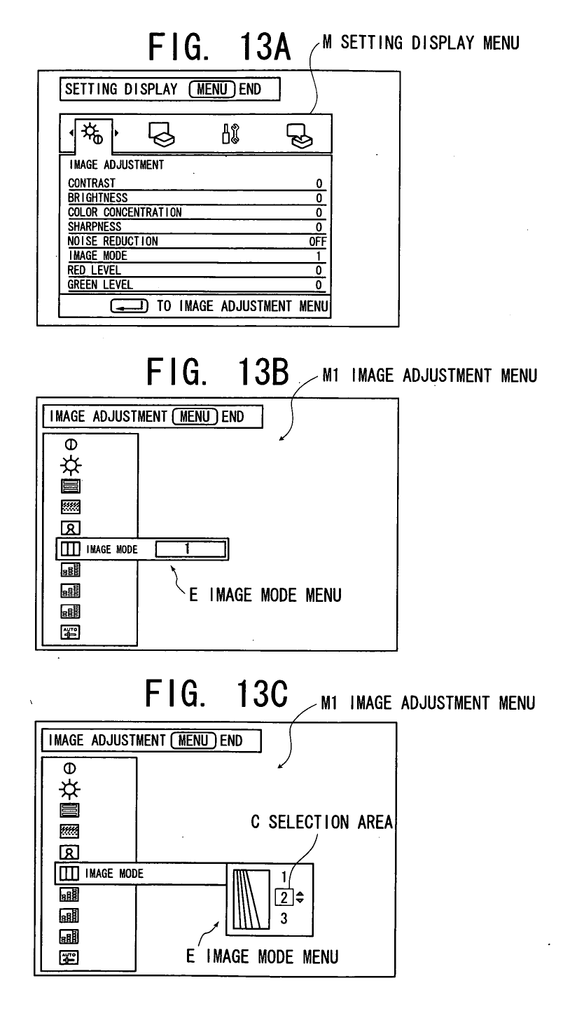

FIGS. 13A, 13B and 13C are respectively a diagram of a display picture about a display image of a setting display menu, a diagram of a display picture about a first display image of an image adjustment menu, and a diagram of a display picture about a second display image of the image adjustment menu, these three kinds of display pictures being displayed in accordance with respective manipulations for the menu switch when the Video signal, the S-Video signal or the Y/P_{B}/P_{R} signal is inputted as the image signal.

While in the setting display menu M for the Video signal, the number of adjustable items in the image adjustment menu M1 increases as compared with that in the setting display menu M for the RGB signals, an image mode menu E has three stages for an adjustment amount. Other structures in the setting display menu M for the Video signal are the same as those in the setting display menu M for the RGB signals.

According to the second embodiment of the present invention, a user or designer can be readily and intuitively adjust the brightness and the color purity in accordance with the manipulation for the image mode menu even by manipulating the menu switch. As a result, the adjustment for the image can be efficiently carried out together with the adjustment for other set items in the setting display menu M.

It should be noted that the present invention is not intended to be limited to the above-mentioned first and second embodiments, and thus the various changes thereof can be made without departing from or changing the technical idea of the invention.

What is claimed is:

1. A projection type image-displaying system, comprising:
a first terminal apparatus for outputting first image signals;
a second terminal apparatus for outputting second image signals;
a projection type image-displaying apparatus; and
a screen having a projection surface on which image lights are projected;
the projection type image-displaying apparatus comprising:
a disk-like color wheel constituting a plurality of color filters including a plurality of color segments for transmitting lights having colors different from one another, respectively;
a lamp for radiating a light to the disk-like color wheel, thereby generating lights having transmission colors corresponding to the plurality of color filters, respectively;
a lamp-controlling portion for superimposing a control current on a driving current for the lamp for a period of time for which the light is radiated from the lamp to one selected among the plurality of color filters;
an optical modulation portion for being driven in accordance with the first image signals or the second image signals to reflect the lights transmitted through the plurality of color filters, respectively, in accordance with the image signals, thereby generating the image lights; and
a control portion connected to the first and second terminal apparatuses for causing an image adjustment menu to be projected on the screen in accordance with a user manipulation, the image adjustment menu having set contents to vary the superimposition of the control current on the driving current in correspondence to the first image signals or the second image signals.

2. A projection type image-displaying system according to claim 1, wherein:
the first terminal apparatus outputs RGB image signals for the first image signals; and
the second terminal apparatus outputs Video image signals for the second image signals.

3. A projection type image-displaying system according to claim 1, wherein:
the lamp-controlling portion superimposes a pulse current for the control current on the driving current for the lamp.

4. A projection type image-displaying system according to claim 3, wherein:
the lamp-controlling portion controls a height of the pulse current in accordance with the image adjustment menu.

5. A projection type image-displaying system according to claim 3, wherein:
the lamp-controlling portion controls a width of the pulse current in accordance with the image adjustment menu.

6. A projection type image-displaying system according to claim 1, wherein:
the control portion causes the image adjustment menu to be projected on the screen in accordance with the manipulation of a main body manipulation portion provided on the projection type image-displaying apparatus.

7. A projection type image-displaying system according to claim 1, wherein:
the control portion causes the image adjustment menu to be projected on the screen in accordance with the manipulation of a remote controller.

8. A projection type image-displaying apparatus, comprising:
a disk-like color wheel constituting a plurality of color filters including a plurality of color segments for transmitting lights having colors different from one another, respectively;
a lamp for radiating a light to the disk-like color wheel, thereby generating lights having transmission colors corresponding to the plurality of color filters, respectively;
a lamp-controlling portion for superimposing a pulse current on a driving current for the lamp for a period of time for which the light is radiated from the lamp to one selected among the plurality of color filters;
an optical modulation portion for being driven in accordance with image signals to reflect the lights transmitted through the plurality of color filters, respectively, in accordance with the image signals, thereby generating the image lights; and
a control portion for causing an image adjustment menu to be projected on the screen in accordance with a user manipulation, the image adjustment menu having set contents to vary the superimposition of the pulse current on the driving current in correspondence to the image signals.

9. A projection type image-displaying apparatus according to claim 8, wherein:
the lamp is driven synchronously with the image signals to radiate the light to the disk-like color wheel.

10. A projection type image-displaying apparatus according to claim 8, wherein:
the control portion causes the image adjustment menu to be projected on the screen in accordance with the manipulation of a main body manipulation portion.

11. A projection type image-displaying apparatus according to claim 8, wherein:
the control portion causes the image adjustment menu to be projected on the screen in accordance with the manipulation of a remote controller.

12. A projection type image-displaying apparatus according to claim 10, wherein:
the main body manipulation portion includes a picture switch to display a menu on the screen, the menu adjusting brightness or color purity of the image lights.

13. A projection type image-displaying apparatus according to claim 11, wherein:
the remote controller includes a picture switch to display a menu on the screen, the menu adjusting brightness or color purity of the image lights.

14. A projection type image-displaying apparatus according to claim 8, wherein:
the disk-like color wheel constitutes the plurality of color filters including red, green, blue and white color segments, the disk-like color wheel being driven to be rotated synchronously with an image field of the image signals.

15. A projection type image-displaying apparatus according to claim 10, wherein:
the main body manipulation portion includes a menu switch to display a setting display menu on the screen, the setting display menu containing a lower layer menu to adjust brightness or color purity of the image lights.

16. A projection type image-displaying apparatus according to claim 11, wherein:
the remote controller includes a menu switch to display a setting display menu on the screen, the setting display menu containing a lower layer menu to adjust brightness or color purity of the image lights.

17. A lamp lighting-controlling method, comprising:
visually observing image lights projected from a projection type image-displaying apparatus on a projection surface of a screen;
reading out a menu to adjust brightness or color purity of the image lights by manipulating the projection type image-displaying apparatus;
setting an adjustment amount corresponding to the brightness or the color purity in accordance with the manipulation of a main body manipulation portion provided on the projection type image-displaying apparatus or a remote controller by looking at the adjustment amount for the brightness or the color purity to be indicated in the menu; and
superimposing a pulse current on a driving current for a lamp for radiating a light to a disk-like color wheel in accordance with an input manipulation using the main body manipulation portion or the remote controller, the disk-like color wheel constituting a plurality of color filters including a plurality of color segments, respectively.

18. A lamp lighting-controlling method according to claim 17, wherein:
the step of reading out a menu reads out a menu corresponding to a kind of image signals inputted to the projection type image-displaying apparatus.

19. A lamp lighting-controlling method according to claim 17, wherein:
when the adjustment amount corresponding to the brightness is set, the pulse current is superimposed on the driving current for a period of time for which the light is radiated to a white segment which is one of the plurality of color segments of the plurality of color filters.

20. A lamp lighting-controlling method according to claim 17, wherein:
when the adjustment amount corresponding to the color purity is set, the pulse current is superimposed on the driving current for a period of time for which the light is radiated to a red segment which is one of the plurality of color segments of the plurality of color filters.
